(19) United States
(12) Patent Application Publication
(10) Pub. No.: US 2013/0101353 A1
(43) Pub. Date: Apr. 25, 2013

(54) SYSTEM AND METHOD FOR ISOLATING AND DECONTAMINATING A BLOCK OF SOIL

(71) Applicants: Guy Bousquet, Paris (FR); Marc Lacazedieu, Paris (FR); Jérôme Stubler, Paris (FR)

(72) Inventors: Guy Bousquet, Paris (FR); Marc Lacazedieu, Paris (FR); Jérôme Stubler, Paris (FR)

(73) Assignee: SOLETANCHE FREYSSINET, Rueil Malmaison (FR)

(21) Appl. No.: 13/806,655

(22) PCT Filed: Jun. 20, 2011
(86) PCT No.: PCT/FR11/51411

§ 371 Date: Dec. 21, 2012

(30) Foreign Application Priority Data
Jun. 24, 2010 (FR) 1055053

(51) Int. Cl. B09C 1/02

(52) U.S. Cl. CPC B09C 1/02
USPC 405/128.3

(57) ABSTRACT

Isolation and decontamination of a block of soil (1) containing at least one pollutant, a first array of drains (11) being placed substantially vertically in the block of soil, a first array of connectors (13) being connected to the drains of the first array of drains. The first array of connectors is selectively connected to a gas and/or fluid extraction system (10) or to an unpolluted-fluid injection system (10).

The present invention relates to the isolation and decontamination of soil.

A block of soil may, for various reasons, contain one or more contaminants. This contamination may, for example, stem from the physicochemical nature of the soil or from the fact that it has become contaminated through contact with a contaminating substance.

Any type of contaminant whatsoever is considered here. By way of nonlimiting example, the contaminant may be radioactive heavy metals (e.g. uranium, plutonium) or non-radioactive heavy metals (e.g. lead), hydrocarbons or other contaminants.

When a block of soil is contaminated, one conventional way of reducing its harmfulness and to limit the spread of the contamination is to use static containment, for example using suitable barriers. Because the contamination remains in situ, somewhat stringent precautions have to be taken. These may go so far as to definitively order a safety zone surrounding the block of contaminated soil.

Where it is practicable, the block of contaminated soil can be removed and placed in a secure storage space designed for that purpose. However, the cost of transporting the block of soil and of keeping it in the storage space is complex and costly. Furthermore, storage space is limited.

It would therefore be preferable to be able to isolate and decontaminate the block of soil in situ. That would in fact, to a certain extent, allow the surroundings of the block of contaminated soil to be restored and avoid the problems associated with transporting the block of soil to and keeping it in a secure storage space.

The invention proposes such an isolation and decontamination solution.

To this end, the invention proposes a system for isolating and decontaminating a block of soil containing at least one contaminant. The system comprises:
a first network of drains laid substantially vertically in the block of soil;
a first network of connectors connected to the drains of the first network of drains;
a gas and/or fluid suction system;
a system for injecting non-contaminated fluid, and
means for connecting the first network of connectors selectively to the suction system or to the injection system.

The selective use of suction and injection means that contaminated fluid can be extracted from the block of soil or a non-contaminated fluid can be introduced into the block of soil, as desired, using the drains and collectors. This mechanism allows the block of soil to be isolated using dynamic containment resulting from the suction. It also allows the block of soil to be decontaminated in situ by extracting the contaminant. A series of injection and suction operation(s) allows the block of soil to be scrubbed progressively in order to tend toward near-total decontamination.

The use of the term “first” to qualify the network of drains and the network of connectors must not be interpreted as necessarily implying the use of several networks of drains and networks of connectors. The first network of drains and the first network of connectors may be the only, although the use of two networks of drains and two networks of connectors, or even more, is equally conceivable.

Where “gas and/or fluid” is mentioned, this may be gas (air or some other gas) containing no or very little liquid, liquid (water or some other liquid) containing no or very little gas, or a mixture of gas and of liquid.

According to advantageous embodiments that can be combined in all conceivable ways:
the system further comprises a second network of drains laid substantially vertically in the block of soil and substantially in alternation with the drains of the first network of drains, and a second network of connectors connected to the drains of the second network of drains, the second network of connectors being able to be connected to the suction system and/or to the injection system. This duplication of the networks of drains and of connectors makes it possible to create a circulation of fluid capable of improving the removal of the contaminant present in the block of soil. The first network of connectors may, for example, be connected to the suction system while the second network of connectors is connected to the injection system (or vice versa);
the system further comprises means for connecting the second network of connectors selectively to the suction system or to the injection system. In this way, the two sets of networks may have a symmetric operation;
the gas and/or fluid suction system is able, at least temporarily, to suck up only gas, so as to keep the block of soil under a depression even when no fluid is being sucked up. This then contributes to preserving isolation by dynamic containment of the block of soil, even when no fluid is circulating;
the suction system and the injection system are designed so that when one out of the first and second networks of connectors is connected to the suction system while the other out of the first and second networks of connectors is connected to the injection system, the pressure resulting from the injection of non-contaminated fluid is lower than the depression caused by sucking-up of the gas and/or of the fluid. Thus, the contaminant may still be removed to the surface, despite the pressure applied by the injection;
the gas and/or fluid suction system is situated outside the block of soil or alternatively inside the block of soil, for example within the drains of the first and/or of the second network of drains. It is equally possible for the suction system to be positioned partially outside of the block of soil and partially inside the block of soil. The same is also potentially true of the system for injecting non-contaminated fluid;
the block of soil is surmounted by an embankment that already exists or is installed when the system is constructed, the connectors of the first and/or of the second network of connectors being laid substantially horizontally in the embankment;
a substantially air- and water-tight membrane covers any embankment there might be and/or the block of soil. This ensures a better depression and affords protection against the ingress of rainwater into any embankment there might be and into the block of soil;
the injection system is also capable of injecting a contaminant-blocking product. This then prevents the contaminant trapped in the block of soil from being able to leach into uncontaminated soil;
the blocking product contains apatite. Such a product appears to be particularly effective in soil decontamination, notably when the contamination is with heavy metals, potentially radioactive ones;
the system further comprises, at the outlet of the suction system, a treatment device for treating the fluid removed so as to extract at least some of the contaminant therefrom. This measure allows the removed fluid to become decontaminated;
the treatment device comprises a filter containing apatite. Such a treatment provides a highly effective decontamination of the removed fluid, notably in the case where the contamination is with heavy metals, potentially radioactive ones;
the apatite is derived from fish parts, such as fish bones or cartilage. This form of apatite yields particularly good results in terms of decontamination;
the injection system is connected to the outlet of the treatment device so that least some of the fluid can be recycled. This then optimizes the use of fluid; and/or
the injection system is able to inject, in addition to non-contaminated fluid, at least one additive able to encourage the contaminant to separate from the material of the block of soil or to promote the mobility of the contaminant within the block of soil. This allows any particles of contaminant which have become bound to the block of soil or which are static within the block of soil to be removed, thus further improving the decontamination.

Another aspect of the invention proposes a method for isolating and decontaminating a block of soil containing at least one contaminant using a system as mentioned hereinabove, a first network of drains being laid substantially vertically in the block of soil, a first network of connectors being connected to the drains of the first network of drains. According to this method, the first network of connectors is connected selectively to a gas and/or fluid suction system or to a system for injecting non-contaminated fluid.

The method advantageously comprises optional steps corresponding to all or some of the means listed above in relation to the system.

Other specific features and advantages of the present invention will become apparent from the following description of nonlimiting exemplary embodiments given with reference to the attached drawings in which:

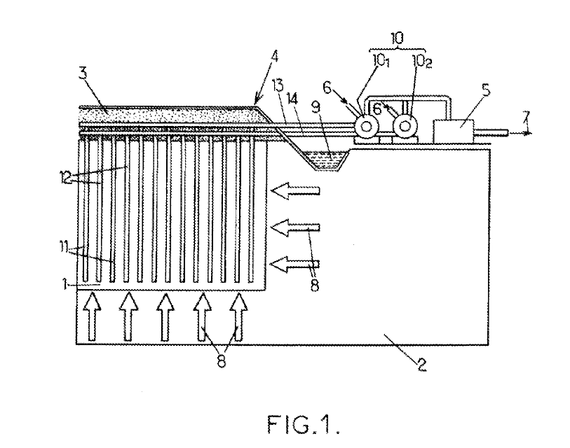

FIG. 1 is a schematic diagram illustrating one advantageous embodiment of the invention;

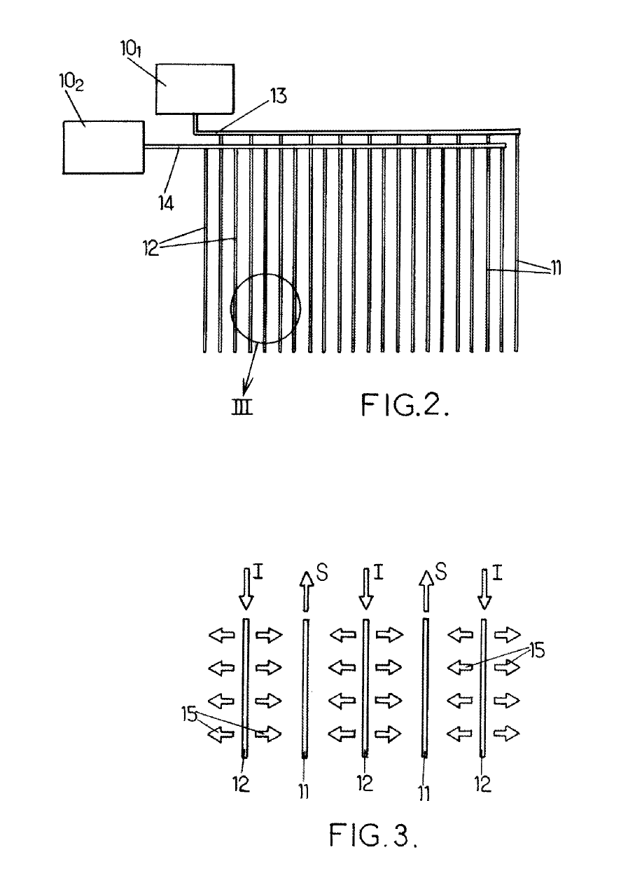

FIG. 2 is a schematic diagram illustrating one advantageous interaction between two networks of drains+collectors;

FIG. 3 is a schematic diagram showing a detail of the operation of FIG. 2 (the detail identified by the reference III);

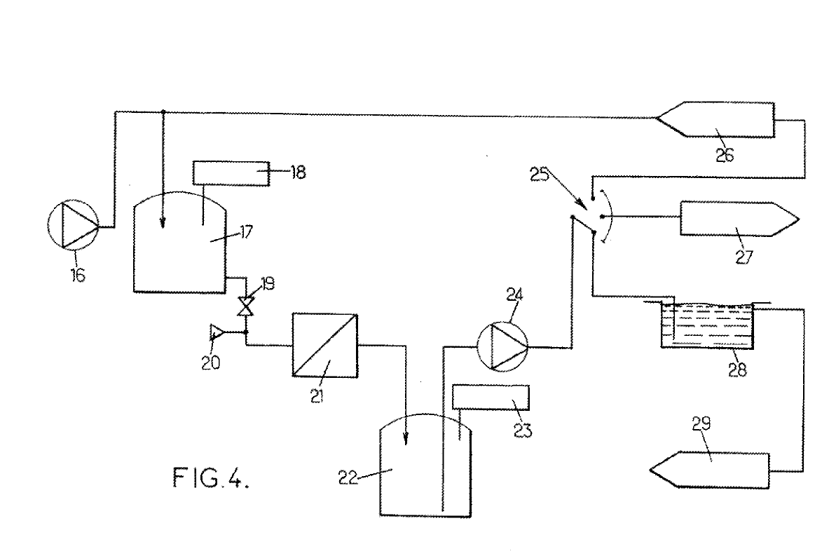

FIG. 4 is a schematic diagram illustrating one advantageous treatment of a fluid as it leaves a suction system.

The system of the invention seeks to isolate and to decontaminate a block of soil containing at least one contaminant which may be any type whatsoever as indicated in the introduction.

Unless specified otherwise hereinafter (notably in terms of the addition of an injection system, the use of connectors directly connected to the drains, etc.), such a system may readopt all or some of the elements of the system described in EP 1 075 570. It will be noted that the system of EP 1 075 570 was intended and designed solely for drying an area of ground containing a liquid, rather than for isolating and decontaminating it.

FIG. 1 shows one nonlimiting example of a system that can be used for isolating and decontaminating the block of soil 1, which may be of any conceivable type. The block of soil 1 may represent the contaminated subpart of a more extensive piece of soil 2.

The block of soil 1 is advantageously surmounted by an embankment 3, which may already exist or alternatively may be installed when the system is constructed. This embankment 3 advantageously does not contain any contaminant, at least when it is being installed on the block of soil 1.

In the example of FIG. 1, two networks of drains 11 and 12 are laid substantially vertically in the block of soil 1. These vertical drains have orifices in that part that is situated in the block of soil 1, so that a fluid (which means a liquid or a gas) present in the block of soil 1 can enter or, on the other hand, leave these drains. They may, for example, be perforated plastic tubes with an inside diameter of, for example, the order of 50 mm. As an alternative, they may be porous tubes. Other alternative versions are of course conceivable.

The drains of the two networks are advantageously positioned in alternation, so that fluid can circulate between the two networks as will become apparent in what follows with reference to FIG. 2. Square meshes with a spacing of one to several meters between the drains may, for example, be used.

These drains may have been installed in the block of soil 1 using drills and/or taps suited to this purpose.

An upper end of these drains is advantageously situated in the embankment.

It will be noted that, although two distinct networks of drains 11 and 12 have been depicted in FIG. 1, just one of these networks could be used within the scope of the invention.

FIG. 1 also shows two networks of connectors 13 and 14 connected respectively to the networks of drains 11 and 12. The connectors 13 are thus connected to the drains 11 in any conceivable way. Likewise, the connectors 14 are connected to the drains 12. Direct connection between the connectors and the drains of each network prevents any potentially contaminated fluid from being able to contaminate the embankment 3 as it circulates between the drains and the connectors.

In the example of FIG. 1, the networks of connectors and 14 are laid substantially horizontally in the embankment 3. As an alternative, one of these networks of connectors, or both, could be laid other than horizontally. Likewise, they could be situated not in the embankment 3, but, for example, in the block of soil 1 or even above the latter.

When the invention uses a single network of drains (for example the drains 11), only the corresponding network of connectors is used (for example the connectors 13).

The system further comprises a gas and/or fluid suction system and a system for injecting non-contaminated fluid. These two systems may, for example, be situated outside the block of soil 1 and outside of any embankment 3 there might be. As an alternative, one of these systems, or both, could be situated in the block of soil 1. By way of example, the gas and/or fluid suction system could be positioned partially within the drains 11 and/or 12.

In FIG. 1, the two, suction and injection, systems have been depicted, with respect to each network of drains and each associated network of connectors, as forming part of a single system 10 able to perform the two functions selectively. As an alternative, the suction system and the injection system could consist of physically distinct systems.

Moreover, the system 10 in FIG. 1 comprises two separate devices respectively in communication with the two networks of drains and associated networks of connectors. Thus, the device 10₁ can be used, as the situation requires, to suck and to inject with respect to the connectors 13 and the drains 11, whereas the device 10₂ can be used, as the situation dictates, to suck and to inject with respect to the connectors 14 and the drains 12. As an alternative, the system 10 could consist of a single device used in communication with the two networks of drains and associated networks of connectors at once, rather than of two distinct devices 10₁ and 10₂.

The network of connectors 13 is connected selectively either to the gas and/or fluid suction system or to the system for injecting non-contaminated fluid. That means that the network of connectors 13 may, as desired, carry a gas and/or a fluid away from the block of soil under the effect of the suction system or alternatively may carry a non-contaminated fluid into the block of soil 1 under the effect of the injection system. A connection between the network of connectors 13 and the gas and/or fluid suction system and/or the system for injecting non-contaminated fluid can be provided for that purpose, for example outside the block of soil 1 and outside the embankment 3. The selection between injection and suction can be made using any means. By way of example, the connection between the network of connectors 13 and the suction system or the injection system could be made only when the desired function (injection or suction) is activated. As an alternative, there may be a permanent connection between the network of connectors 13 on the one hand and the suction and injection systems on the other. In the latter case, a switch may be used to activate injection or suction as desired. A system of check valves, valves or one-way valves may make it possible to inhibit the function that is not being selected. For example, the connectors 13 having passed through the membrane 4 may be connected to the suction system or to the injection system, a set of automatic valves isolating the non-selected function and connecting the selected function.

The selection between injection and suction can be made manually or in an automated fashion. It may be triggered at determined moments in time, for example periodically, or alternatively when certain events occur, these for example being connected with a monitoring of a quantity of fluid sucked up and/or of a level of contamination in the sucked-up fluid.

By way of illustration, if, at a given moment in time, the quantity of fluid sucked up drops below a threshold (or exhibits a rate of decrease that starts to fall below a threshold), there is a switch to injection mode, for example for a set length of time. According to another nonlimiting example, if, at a given moment in time, the quantity of contaminant present in the sucked-up fluid drops below a threshold (or exhibits a rate of decrease that starts to fall below a threshold), there is a switch to injection mode, for example for a set length of time.

When the network of connectors 13 is connected to the gas and/or fluid suction system, this system sucks up a certain volume or flow rate of gas and/or fluid from the embankment 3 and from the block of soil 1 and into the suction system. The fluid in question may be water or some other type of nonspecified liquid, or even alternatively some nonspecified gas. The gas or gases in question may be air or some other type of gas or combinations of nonspecified gases. The suction system may, for example, comprise a suitable pump, for example like the one described in EP 1 075 570.

The suction system is advantageously provided so that the volume or flow rate of gas, e.g. air, sucked up creates, in the block of soil 1 and in any embankment 3 there might be, a depression (i.e. a difference in pressure in relation to atmospheric pressure) of at least 0.1 bar. Under the effect of this depression, fluid present in the soil 2 has a tendency to be drawn toward the block of soil 1, as illustrated by the arrows 8. Within the block of soil 1, the fluid has a tendency to rise up toward the embankment 3 through the network of drains 11.

The suction of fluid performed by the suction system through the network of connectors 13 also makes it possible to increase the collection of the fluid present in the block of soil 1 and its ascent in the vertical drains 11. The fluid thus sucked up can be removed out of the block of soil 1.

The suction that has just been described makes it possible to obtain a very attractive form of isolation because by drawing the fluid to the surface and removing it there, the contaminant contained in the block of soil 1 is prevented from leaching into the soil 2. Such dynamic containment also avoids the need to install static barriers around the block of soil 1. In the example that has just been described, the suction system is a single device connected to the network of connectors 13. As an alternative, several devices could be used. By way of example, the device 10₁ could suck only fluid through the network of connectors 13 while another device could be dedicated to sucking gas (for example air) through another pipe laid, for example, horizontally in the embankment. As this pipe is not in contact with contaminated fluid, it would be able to comprise orifices able to improve the suction of air in the embankment.

According to another alternative form, the suction system could perform just one of the two types of suction rather than both at once. For example, it could suck only fluid (for example water) or alternatively only gas (for example air).

The injection system has an available supply of non-contaminated fluid, either because it stores such fluid directly within it or because it receives such fluid from an inlet represented by the arrow 6 in FIG. 1. When the network of connectors 13 is connected to the injection system, the latter injects through the connectors 13 a certain volume or flow rate of non-contaminated fluid. The fluid in question may be water or any other type of liquid, or even any gas. It is advantageously chosen so that it can be sucked by the suction system, even though the latter may potentially be capable also of sucking other fluids. By way of example, the suction system may be designed to suck the injected fluid, and also to suck residual water present in the block of soil 1 independently of any injection.

Under the effect of the pressure of injection, the injected fluid enters the network of connectors 13 and descends through the associated network of vertical drains 11. As it does so, fluid enters the block of soil 1 via the drains 11. The block of soil 1 thus becomes laden with non-contaminated fluid.

It will thus be appreciated that a succession of injection(s) of non-contaminated fluid and suction(s) of gas and/or fluid by alternate activation of the injection and suction systems allows the block of soil 1 progressively to be cleaned. Specifically, the fluid injected becomes laden with contaminant present in the block of soil 1, then as it is sucked up at least some of this contaminant is removed with the sucked-up fluid.

Such decontamination of the block of soil 1 is particularly well controlled because the quantity of fluid introduced into the block of soil 1 and removed from this block of soil 1 can be controlled with precision, during the injection and suction steps.

In addition to performing its role in decontamination of the block of soil 1, it will be noted that the injection of fluid into the vertical drains 11, via the connectors 13, allows the drains to be cleaned and unblocked, notably when relatively large particles of soil have managed to enter these drains. Any need to remove the drains from the block of soil in order to clean or even replace them is thus avoided.

The network of connectors 14 associated with the network of vertical drains 12 may operate in a similar way to the network of connectors 13 associated with the network of vertical drains 11. Thus, it can be connected selectively to the suction system or to the injection system (device 10₂ in FIG. 1).

That being the case, it may be advantageous, at certain moments in time, to use the suction system and the injection system in such a way that non-contaminated fluid is injected into the network of connectors 14 while the network of connectors 13 is subjected to gas and/or fluid suction (or vice versa).

This situation is illustrated in FIGS. 2 and 3, in a configuration in which the drains 11 and 12 are arranged alternately in the block of soil 1.

Non-contaminated fluid injected into the network of connectors 14 enters the block of soil 1 by descending into the corresponding drains 12, as is illustrated by the arrows 15. That causes fluid to circulate between the drains 12 and the adjacent drains 11. In its path, the injected fluid becomes laden with contaminant upon contact with the block of soil 1. Fluid coming near the drains 11 therefore contains contaminant. Under the action of the combined suction through the network of connectors 13, this contaminated fluid is collected by the drains 11 and removed to the suction system. The quantity of contaminant in the block of soil 1 thus decreases.

Advantageously, the pressure resulting from the injection of the non-contaminated fluid into the network of connectors 13 is chosen to be lower than the depression caused by the sucking of gas and/or fluid through the network of connectors 14, for example of at least 0.1 bar. In this way, the fluid can be certain to continue to ascend in the vertical drains 11 and dynamic containment of the block of soil 1 is certain to be achieved.

Because of the ability to select the mode of operation (injection and/or suction) it is possible, at other moments in time, to contrive for gas and/or fluid to be sucked through both networks of connectors 13 and 14 simultaneously. Such suction is particularly effective. It may, for example, be used when the block of soil 1 is already laden with fluid (for example water) without any additional injection of fluid being needed.

It is also possible to conceive of simultaneous injection with fluid through both networks of connectors 13 and 14 at other moments in time.

It will also be noted that the ability to connect one network of connectors selectively to the suction system or to the injection system could be reserved for the network of connectors 13, while the network of connectors 14 would be subjected either to suction or to injection without the possibility of switching between these two modes of operation.

Still other configurations are conceivable within the context of the present invention, as will be apparent to the person skilled in the art. By way of example, the number, distribution and geometry of the networks of connectors and of drains could differ from that which has been described above.

In one advantageous embodiment, the embankment 3 (or alternatively the block of soil 1 itself if there is no embankment) is covered with a substantially air- and water-tight membrane 4. The membrane 4 is also potentially impermeable to the fluid injected into the block of soil 1 by the injection system, just in case this fluid should enter the embankment 3. Likewise, it is also possibly impermeable to the fluid sucked up by the suction system.

The membrane 4 is, for example, a strong membrane made of rubber or some other material. The periphery of this membrane 4 is advantageously sealed using a trench 9 dug into the soil 2 at the periphery of the block of soil 1. This trench 9 is, for example, filled with water and/or with a sealant or sealing material such as a bentonite slurry. The peripheral edge of the membrane 4 may then be immersed in the trench 9.

The use of a membrane 4 accelerates and improves the obtaining of the depression under the effect of the suction system. It also protects any embankment 3 there might be and the block of soil 1 against the ingress of rainwater and against other uncontrolled natural phenomena. Thus, the amount of water or fluid present in the block of soil 1 can be fully controlled.

When a membrane 4 is used, the connection between the network of connectors 13 and/or 14 advantageously passes through it in a way that is impermeable to air and to water, in order as far as possible to preserve the advantages conferred by this membrane.

The contaminated water removed from the block of soil 1 can be treated so that at least some of the contaminant it contains is extracted from it. To this end, a device 5 for treating the removed fluid may be positioned on the outlet side of the suction system 10, for example at the surface. This treatment device may, for example, comprise a filter suited to the contaminant that is to be extracted. Such a filter may be a conventional filter.

Advantageously, the filter used may contain apatite or a similar substance. It will be recalled that apatite denotes hexagonal phosphates of very variable composition. The species of apatite notably comprise chlorapatite Ca5(PO4)3Cl, fluorapatite Ca5(PO4)3F and hydroxylapatite Ca5(PO4)3(OH). Apatite works by trapping the ions of certain contaminants, such as heavy metals, whether these are radioactive heavy metals (e.g. uranium, plutonium) or non-radioactive heavy metals (e.g. lead). This trap forms a highly stable matrix capable of trapping the contaminant for extremely lengthy periods of time.

Although apatite can be used in the filter in synthetic form, preference may be given to a natural form of apatite derived for example from fish parts, such as fish bones or cartilage, the performance of which is particularly advantageous in the context of decontamination. These fish parts can be used without further treatment, or after their structure has been modified for example by crushing them or grinding them to powder.

The filter used may, for example, comprise one or more cartridges containing apatite, through which the sucked-up fluid is passed. The fluid thus filtered is rid of at least some of its contaminant (arrow 7 in FIG. 1).

The at least partially decontaminated fluid leaving the treatment device 5 can then be used for other purposes. Advantageously, it can be at least partially recycled by injecting it into the block of soil 1. For that purpose, the injection system may be connected to the outlet of the treatment device 5 (arrow 7 then links back to arrow 6), intermediate means potentially being positioned in between. This then limits the quantity of fluid needed to operate the system, and fluid storage and transport operations are economized. Repeated filtrations of fluid, followed by a series of injection and suction operations, also make it possible to tend toward a complete decontamination of the residual fluid in the block of soil 1.

FIG. 4 shows a detailed nonlimiting example of operations that may be carried out on the outlet side of the suction system.

The reference 16 represents a gas (for example air) and fluid (for example water) pump that could form part of the suction system. This pump 16 is, for example, connected to the network of connectors 13 and/or to the network of connectors 14 mentioned above.

The gas and fluid obtained on the outlet side of the pump 16 are then conveyed to a buffer reservoir 17. This reservoir allows the fluid to be stored and the gas removed. Instrumentation 18 may be associated with the buffer reservoir 17 in order to evaluate the cleanliness of the fluid at this stage. The measurement taken by the instrumentation 18 may be of any conceivable kind. It may for example involve measuring the concentration of a contaminant in the fluid, or something else. A radiation sensor may thus be conceived of in the case of a radioactive contaminant. This measurement may then potentially be compared against a measurement taken further on, for example on the outlet side of the filter 21, in order to check the effectiveness of the system.

A regulating valve 19 is positioned on the outlet side of the buffer reservoir 17 to control the flow rate of fluid entering the filter 21, for example to take the capacity and/or effectiveness thereof into consideration.

A sample 20 of fluid may advantageously be withdrawn for more in-depth analysis, for example relating to the cleanliness of the fluid before it enters the filter 21.

The filter 21 is, for example, a filter containing apatite as described above. Several filters 21 may be fitted if need be, in parallel or in series, in order to increase the throughput and/or the efficiency of the filtration. The fluid at least partially decontaminated under the effect of the filter 21 is then introduced into a new collecting buffer reservoir 22.

Instrumentation 23 may be associated with this reservoir in order to evaluate the cleanliness of the fluid at this stage. The measurement taken may be similar to that taken by the instrumentation 18. It makes it possible to determine whether the filtration has been effective, potentially by comparing the measurement obtained upstream of the filter 21, and/or if the filter 21 or one of the filters 21 needs to be cleaned or even replaced. A filter change has, for example, to be planned when the apatite present in this filter is saturated with contaminant and can therefore no longer capture any further contaminant ions.

A fluid pump 24 collects the fluid contained in the buffer reservoir 22 and conveys it to a branch that opens onto three separate pathways in the example illustrated in FIG. 4. A switch 25 or some other form of routing device may allow the fluid delivered by the pump 24 to be placed in communication with one of the three paths selectively. The selection of a particular path may be dictated by the measurements taken by the instrumentation 24, possibly in combination with the instrumentation 18.

The upper path 26 passes back through the filter 21. This path may, for example, be taken when the cleanliness of the fluid as measured by the instrumentation 24, possibly in comparison with a measurement taken by the instrumentation 18, is deemed to be too low, for example in relation to a suitable threshold.

The intermediate path 27 is used for discharging the decontaminated fluid. This option may, for example, be taken in order to get rid of excess fluid in an overflow scenario.

The lower path, finally, recycles the decontaminated fluid by conveying it to the injection system 29 so that it can be injected into the block of soil to be isolated and decontaminated. This path can be taken only when the cleanliness of the fluid as measured by the instrumentation 24, possibly in comparison with a measurement taken by the instrumentation 18, is deemed to be satisfactory, for example with respect to a suitable threshold.

The basin 28 positioned between the switch 25 and the injection system 29 allows the decontaminated fluid to be stored temporarily and returned to a pressure compatible with being introduced into the injection system 29, for example atmospheric pressure.

A person skilled in the art will appreciate that the various means described with reference to FIG. 4 are merely examples. Numerous alternative forms thereof are possible.

According to one advantageous embodiment of the invention, which can be used alone or in combination with any other embodiment described above, a contaminant-blocking product can be injected by the injection system. In such an instance, the blocking product follows the same path as the injected fluid, i.e. it passes through the network of connectors 13 and/or 14, and then descends along the network of drains 11 and/or 12.

The blocking product is advantageously chosen according to the contaminant present in the block of soil 1. It may, for example, contain apatite.

It thus has the effect of fixing the contaminant in the block of soil 1, more particularly in and around the drains. The contaminant is thus blocked in a rigid matrix when suction is activated. Such fixing of the contaminant prevents it from leaching into the rest of the soil 2.

Any other suitable blocking product is equally conceivable. Such a product may, for example, block the contaminant via a chemical reaction or mechanically, e.g. by fixing it in housings or cells of said product.

According to another advantageous embodiment of the invention, which can be used alone or in combination with any other embodiment described above, the injection system injects, in addition to non-contaminated fluid, at least one additive able to encourage the contaminant to separate from the material of the block of soil 1. The additive used (the diluent, solvent or the like) is suited to the contaminant present in the block of soil 1. It must preferably not itself be a source of contamination after rinsing.

The additive may be injected at the same time as the non-contaminated fluid, or independently. In both instances, the additive follows the same path as the injected fluid, i.e. it passes through the network of connectors 13 and/or 14 and then descends along the network of drains 11 and/or 12. It therefore to a certain extent enters the block of soil 1.

The additive injected has the effect of detaching particles of contaminant that have become bound to the material of the block of soil 1. This effect is achieved for example by a reaction that allows the soil to be “scrubbed” using a surfactant principle (for example using natural soap), an electrochemical, clinical, gas diffusion or bacterial principle. The detached particles are then able to be sucked up with fluid when the suction system is activated. The ability of the system to extract the contaminant from the block of soil 1 and therefore to decontaminate the latter is thus improved.

An additive dosing system can be used to control the quantity of additive introduced into the injection system and thus gain better control over the reaction between the additive and the material of the block of soil 1.

Other alternative forms and advantageous embodiments may also be conceived of within the context of the present invention.

1. A system for isolating and decontaminating a block of soil containing at least one contaminant, the system comprising:
a first network of drains laid substantially vertically in the block of soil;
a first network of connectors connected to the drains of the first network of drains;
a gas and/or fluid suction system; and
a system for injecting non-contaminated fluid, wherein the first network of connectors is selectively connectable to the suction system or to the injection system.

2. The system as claimed in claim 1, further comprising a second network of drains laid substantially vertically in the block of soil and substantially in alternation with the drains of the first network of drains, and a second network of connectors connected to the drains of the second network of drains, the second network of connectors being able to be connected to the suction system and/or to the injection system.

3. The system as claimed in claim 2, wherein the second network of connectors is selectively connectable to the suction system or to the injection system.

4. The system as claimed in claim 1, wherein the gas and/or fluid suction system is able, at least temporarily, to suck up only gas, so as to keep the block of soil under a depression even when no fluid is being sucked up.

5. The system as claimed in claim 1, wherein the suction system and the injection system are designed so that when one out of the first and second networks of connectors is connected to the suction system while the other out of the first and second networks of connectors is connected to the injection system, the pressure resulting from the injection of non-contaminated fluid is lower than the depression caused by sucking-up of the gas and/or of the fluid.

6. The system as claimed in claim 1, for isolating and decontaminating a block of soil surmounted by an embankment that already exists or is installed when the system is constructed, wherein the connectors of the first network of connectors are laid substantially horizontally in the embankment.

7. The system as claimed in claim 6, wherein a substantially air- and water-tight membrane covers the embankment and/or the block of soil.

8. The system as claimed in claim 1, wherein the injection system is also capable of injecting a contaminant-blocking product.

9. The system as claimed in claim 8, wherein product contains apatite.

10. The system as claimed in claim 1, further comprising, at the outlet of the suction system, a treatment device for treating the fluid removed so as to extract at least some of the contaminant therefrom.

11. The system as claimed in claim 10, wherein the treatment device comprises a filter containing apatite.

12. The system as claimed in claim 9, wherein the apatite is derived from fish parts, such as fish bones or cartilage.

13. The system as claimed in claim 10, wherein the injection system is connected to the outlet of the treatment device so at least some of the fluid can be recycled.

14. The system as claimed in claim 1, wherein the injection system is able to inject, in addition to non-contaminated fluid, at least one additive able to encourage the contaminant to separate from the material of the block of soil or to promote the mobility of the contaminant within the block of soil.

15. A method for isolating and decontaminating a block of soil containing at least one contaminant, the method comprising:
arranging a first network of drains substantially vertically in the block of soil;
connecting a first network of connectors to the drains of the first network of drains;
providing a gas and/or fluid suction system;
providing a system for injecting non-contaminated fluid; and
selectively connecting the first network of connectors to the suction system or to the injection system.

16. The method as claimed in claim 15, further comprising:
arranging a second network of drains substantially vertically in the block of soil and substantially in alternation with the drains of the first network of drains; and
connecting a second network of connectors to the drains of the second network of drains and selectively to the suction system or the injection system.

17. The method as claimed in claim 16, further comprising:
sucking up only gas, at least temporarily, using the gas and/or fluid suction system, so as to keep the block of soil under a depression even when no fluid is being sucked up.

18. The method as claimed in claim 15, wherein the suction system and the injection system are designed so that when one of the first and second networks of connectors is connected to the suction system while the other out of the first and second networks of connectors is connected to the injection system, the pressure resulting from the injection of non-contaminated fluid is lower than the depression caused by sucking-up of the gas and/or of the fluid.

19. The system as claimed in claim 2, for isolating and decontaminating a block of soil surmounted by an embankment that already exists or is installed when the system is constructed, wherein the connectors of the second network of connectors are laid substantially horizontally in the embankment.

20. The system as claimed in claim 11, wherein the apatite is derived from fish parts, such as fish bones or cartilage.
